(19) United States
(12) Patent Application Publication
(10) Pub. No.: US 2016/0330570 A1
(43) Pub. Date: Nov. 10, 2016

(54) Proximity Alarm System

(71) Applicant: Charles Reed, West Palm Beach, FL (US)

(72) Inventor: Charles Reed, West Palm Beach, FL (US)

(21) Appl. No.: 14/706,962

(22) Filed: May 8, 2015

(51) Int. Cl. H04W 4/00; H04W 68/00; H04W 4/04; H04B 1/3827

(52) U.S. Cl. CPC H04W 4/005; H04B 1/385; H04W 68/00; H04W 4/046; H04B 2001/3861

(57) ABSTRACT

A proximity alarm system includes a vehicle that may have a user and a child positioned therein. A base unit is provided and the base unit may be worn by the child when the child is in the vehicle. A remote unit is provided and the remote unit may be worn by the user. The remote unit is in electrical communication with the base unit wherein the remote unit determines a distance between the base unit and the remote unit. The remote unit issues an alarm when the remote unit is moved beyond a trigger distance from the base unit. Thus, the remote unit alerts the user that the child has been left in the vehicle.

### BACKGROUND OF THE DISCLOSURE

1. Field of the Disclosure

The disclosure relates to alarm devices and more particularly pertains to a new alarm device for alerting a user when the user leaves a child unattended in a vehicle.

2. Summary of the Disclosure

An embodiment of the disclosure meets the needs presented above by generally comprising a vehicle that may have a user and a child positioned therein. A base unit is provided and the base unit may be worn by the child when the child is in the vehicle. A remote unit is provided and the remote unit may be worn by the user. The remote unit is in electrical communication with the base unit wherein the remote unit determines a distance between the base unit and the remote unit. The remote unit issues an alarm when the remote unit is moved beyond a trigger distance from the base unit. Thus, the remote unit alerts the user that the child has been left in the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a proximity alarm system according to an embodiment of the disclosure.

FIG. 2 is a top in-use view of an embodiment of the disclosure.

FIG. 3 is a top view of an embodiment of the disclosure.

FIG. 4 is a bottom view of an embodiment of the disclosure.

FIG. 5 is a schematic view of an embodiment of the disclosure.

FIG. 6 is a perspective in-use view of an embodiment of the disclosure.

### DESCRIPTION OF THE PREFERRED EMBODIMENT

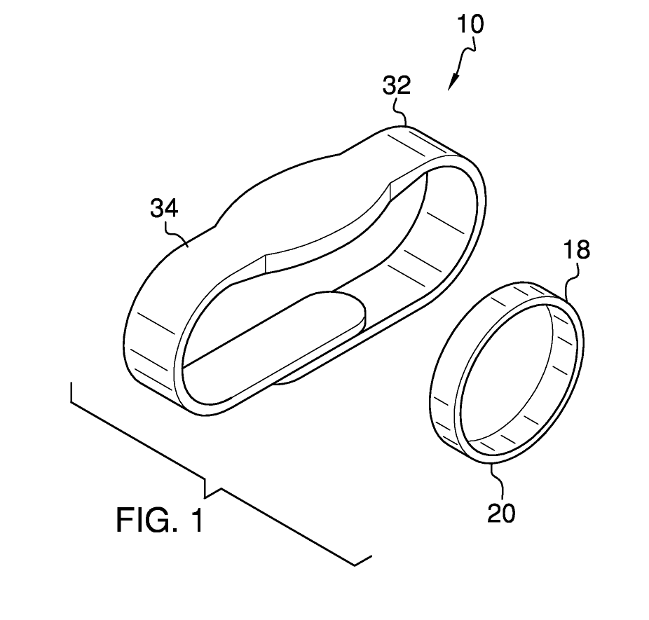

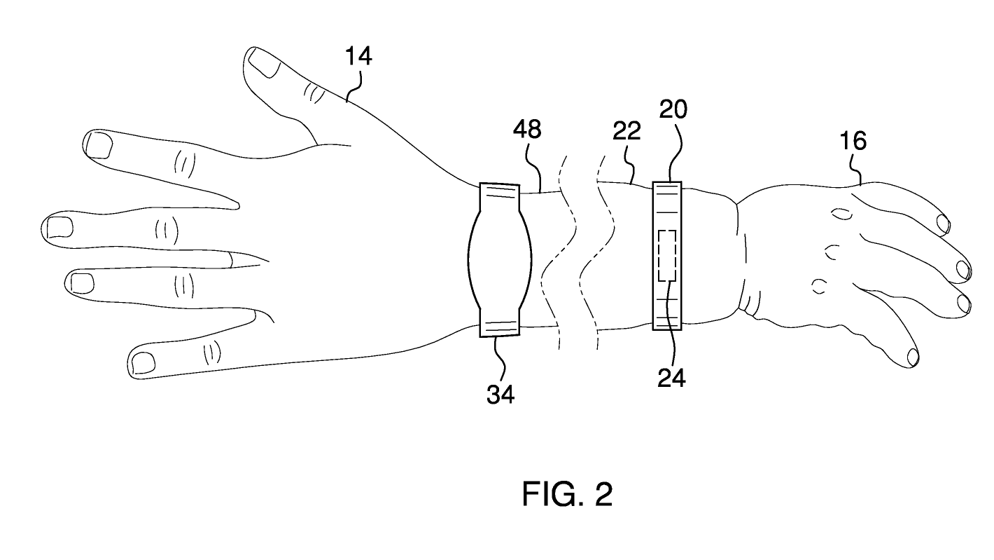

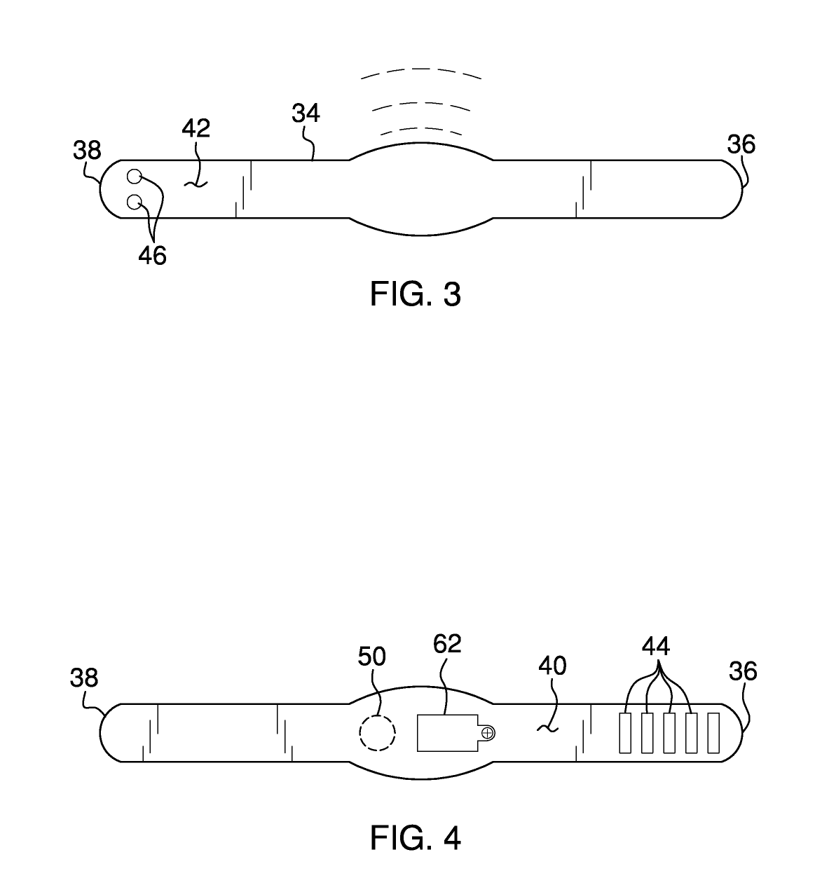

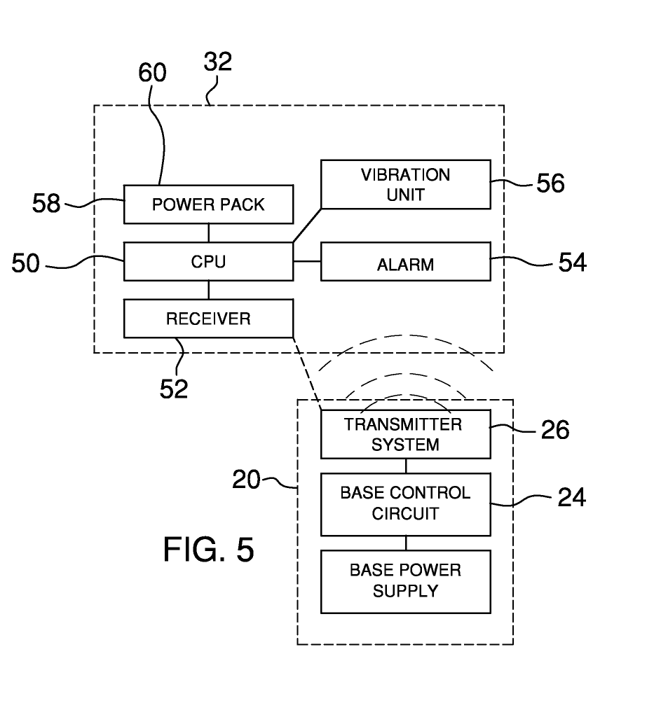

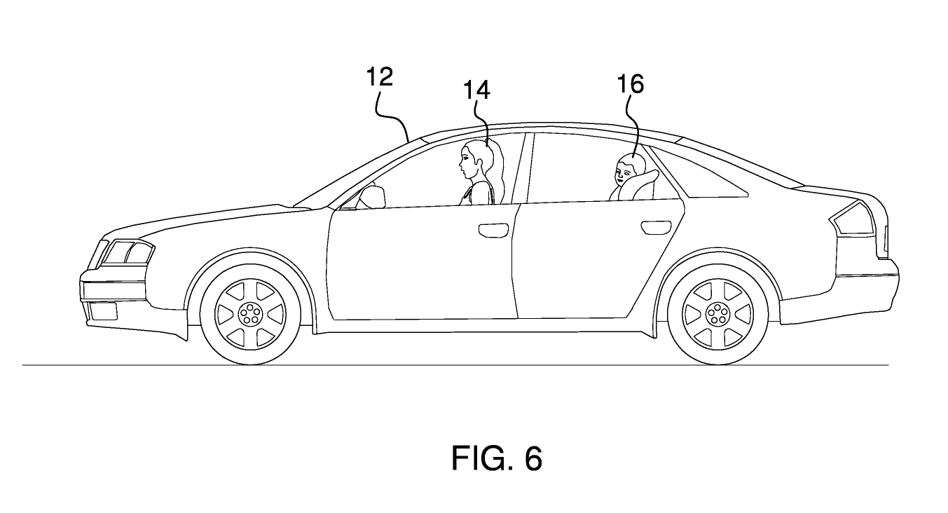

With reference now to the drawings, and in particular to FIGS. 1 through 6 thereof, a new alarm device embodying the principles and concepts of an embodiment of the disclosure and generally designated by the reference numeral 10 will be described.

As best illustrated in FIGS. 1 through 6, the proximity alarm system 10 generally comprises a vehicle 12 that may have a user 14 and a child 16 positioned therein. The vehicle 12 may be a passenger vehicle or the like. A base unit 18 is provided and the base unit 18 may be worn by the child 16 when the child 16 is in the vehicle 12. The base unit 18 comprises a bracelet 20 that may be worn on a wrist 22 of the child 16 and the bracelet 20 may be comprised of a resiliently stretchable material.

A base control circuit 24 is positioned within the bracelet 20 and a transmitter 26 is positioned within the bracelet 20. The transmitter 26 is electrically coupled to the base control circuit 24 and the transmitter 26 may comprise a radio frequency transmitter or the like. A base power supply 28 is positioned within the bracelet 20 and the base power supply 28 is electrically coupled to the base control circuit 24. The base power supply 28 comprises at least one battery 30.

A remote unit 32 is provided and the remote unit 32 may be worn on the user 14. The remote unit 32 is in electrical communication with the base unit 18 wherein the remote unit 32 determines a distance between the base unit 18 and the remote unit 32. The remote unit 32 issues an alarm when the remote unit 32 is moved beyond a trigger distance from the base unit 18. Thus, the remote unit 32 alerts the user 14 that the child 16 has been left in the vehicle 12.

The remote unit 32 comprises a strap 34 that has a first end 36 and a second end 38. The strap 34 has a first surface 40 and a second surface 42. The first surface 40 has a plurality of grooves 44 extending inwardly toward the second surface 42. The grooves 44 are spaced apart from each other and distributed from the first end 36 toward the second end 38. A pair of knobs 46 is attached to the second surface 42 and each of the knobs 46 is positioned adjacent to the second end 38. The pair of knobs 46 frictionally engages a selected one of the grooves 44 such that the strap 34 forms a closed loop having an adjustable diameter. Thus, the first end 36 and the second end 38 are matable wherein the strap 34 may be worn on a wrist 48 of the user 14.

A remote control circuit 50 is positioned within the strap 34. The remote control circuit 50 may comprise a processor or the like. A receiver 52 is positioned within the strap 34. The receiver 52 may be a radio frequency receiver or the like. The receiver 52 is electrically coupled to the remote control circuit 50 and the receiver 52 is in electrical communication with the transmitter 26.

An alarm 54 is positioned within the strap 34 and the alarm 54 is electrically coupled to the remote control circuit 50. The alarm 54 detects a signal strength of the transmitter 26 wherein the alarm 54 determines a distance between the transmitter 26 and the receiver 52. The alarm 54 generates an alarm sequence when the distance between the transmitter 26 and the receiver 52 exceeds a pre-determined trigger distance. The trigger distance may be a distance ranging between approximately 20 feet and 40 feet.

A vibration unit 56 is positioned within the strap and the vibration unit 56 is electrically coupled to the remote control circuit 50. The vibration unit 56 is turned on when the alarm 54 generates the alarm sequence such that the vibration unit 56 alerts the user 14 that the child 16 remains in the vehicle 12 when the user 14 walks away from the vehicle 12. Thus, the vibration unit 56 prevents the user 14 from inadvertently leaving the child 16 unattended in the vehicle 12.

A remote power supply 58 is positioned within the strap 34. The remote power supply 58 is electrically coupled to the remote control circuit 50 and the remote power supply 58 comprises at least one battery 60. A battery cover 62 is removably coupled to the first surface 40 of the strap 34. The remote power supply 58 is positioned beneath the battery cover 62.

In use, the bracelet 20 is placed on the child 16 and the strap 34 is placed on the user 14 when each of the user 14 and the child 16 travel in the vehicle 12. The vibration unit 56 provides haptic feedback if the user 14 walks away the vehicle 12 while the child 16 remains in the vehicle 12. Thus, the strap 34 prevents the user 14 from inadvertently leaving the child 16 in the vehicle 12 thereby preventing the child 16 from being injured by heat exposure or from being left unattended in the vehicle 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A proximity alarm system configured to issue an alert when a child is left in a vehicle, said system comprising:
a vehicle configured to have a user and a child positioned therein;
a base unit configured to be worn by the child when the child is in said vehicle wherein said base unit comprises a bracelet configured to be worn on a wrist of the child, a base control circuit being positioned within said bracelet; and
a remote unit configured to be worn by the user, said remote unit being in electrical communication with said base unit wherein said remote unit determines a distance between said base unit and said remote unit, said remote unit issuing an alarm when said remote unit is moved beyond a trigger distance from said base unit wherein said remote unit is configured to alert the user that the child has been left in said vehicle.

2. (canceled)

3. The assembly according to claim 1, wherein a transmitter is positioned within said bracelet, said transmitter being electrically coupled to said base control circuit.

4. The assembly according to claim 3, wherein a base power supply being positioned within said bracelet, said base power supply being electrically coupled to said base control circuit, said base power supply comprising at least one battery.

5. The assembly according to claim 1, wherein said remote unit comprises a strap having a first end and a second end, said first end and said second end being matable wherein said strap is configured to be worn on a wrist of a user.

6. The assembly according to claim 5, further comprising:
a remote control circuit being positioned within said strap; and
a receiver being positioned within said strap, said receiver being electrically coupled to said remote control circuit, said receiver being in electrical communication with said transmitter.

7. The assembly according to claim 6, further comprising an alarm being positioned within said strap, said alarm being electrically coupled to said remote control circuit, said alarm detecting a signal strength of said transmitter wherein said alarm determines a distance between said transmitter and said receiver, said alarm generating an alarm sequence when said distance between said transmitter and said receiver exceeds a pre-determined trigger distance.

8. The assembly according to claim 7, further comprising a vibration unit being positioned within said strap, said vibration unit being electrically coupled to said remote control circuit, said vibration unit being turned on when said alarm generates said alarm sequence wherein said vibration unit is configured to alert the user that the child remains in the vehicle when the user walks away from said vehicle thereby preventing the user from inadvertently leaving the child unattended in said vehicle.

9. The assembly according to claim 6, wherein a remote power supply being positioned within said strap, said remote power supply being electrically coupled to said remote control circuit, said remote power supply comprising at least one battery.

10. A proximity alarm system configured to issue an alert when a child is left in a vehicle, said system comprising:
a vehicle configured to have a user and a child positioned therein;
a base unit configured to be worn by the child when the child is in said vehicle, said base unit comprising:
a bracelet configured to be worn on a wrist of the child,
a base control circuit being positioned within said bracelet,
a transmitter being positioned within said bracelet, said transmitter being electrically coupled to said base control circuit, and a base power supply being positioned within said bracelet, said base power supply being electrically coupled to said base control circuit, said
base power supply comprising at least one battery;
a remote unit configured to be worn by the user, said remote unit being in electrical communication with said base unit wherein said remote unit determines a distance between said base unit and said remote unit, said remote unit issuing an alarm when said remote unit is moved beyond a trigger distance from said base unit wherein said remote unit is configured to alert the user that the child has been left in said vehicle, said remote unit comprising:
a strap having a first end and a second end, said first end and said second end being matable wherein said strap is configured to be worn on a wrist of a user,
a remote control circuit being positioned within said strap,
a receiver being positioned within said strap, said receiver being electrically coupled to said remote control circuit, said receiver being in electrical communication with said transmitter,
an alarm being positioned within said strap, said alarm being electrically coupled to said remote control circuit, said alarm detecting a signal strength of said transmitter wherein said alarm determines a distance between said transmitter and said receiver, said alarm generating an alarm sequence when said distance between said transmitter and said receiver exceeds a pre-determined trigger distance,
a vibration unit being positioned within said strap, said vibration unit being electrically coupled to said remote control circuit, said vibration unit being turned on when said alarm generates said alarm sequence wherein said vibration unit is configured to alert the user that the child remains in the vehicle when the user walks away from said vehicle thereby preventing the user from inadvertently leaving the child unattended in said vehicle, and
a remote power supply being positioned within said strap, said remote power supply being electrically coupled to said remote control circuit, said remote power supply comprising at least one battery.
